(19) United States
(12) Patent Application Publication
(10) Pub. No.: US 2023/0249628 A1
(43) Pub. Date: Aug. 10, 2023

(54) Loading apparatus for loading an elongate cargo onto a truck

(71) Applicant: Paul Garvoille, Albany, WI (US)

(72) Inventor: Paul Garvoille, Albany, WI (US)

(21) Appl. No.: 17/668,076

(22) Filed: Feb. 9, 2022

(51) Int. Cl. B60R 9/08

(52) U.S. Cl. CPC B60R 9/08

(57) ABSTRACT

A loading apparatus is disclosed for loading an elongate cargo onto a truck, the truck having a cab, tailgate and a truck bed. The loading apparatus includes a table connected to the truck. The table includes a tabletop having a cab end which is disposed above and adjacent to the cab. A tailgate end is disposed above and in a vicinity of the tailgate. The tabletop defines an open-ended slot. The open-ended slot has an open-ended termination and a further termination which is disposed between the tailgate end of the tabletop and the cab end of the tabletop. A support depends from the tabletop for rigidly securing the tabletop to the truck. A platform has a first extremity and a second extremity, the platform being pivotally secured to the tabletop about a first axis of rotation. The first axis of rotation is disposed between the first extremity and the second extremity of the platform. A leg has a proximal end and a distal end, the proximal end of the leg being pivotally secured to the platform about a second axis of rotation. The second axis of rotation is disposed spaced and parallel relative to the first axis of rotation. The second axis of rotation is disposed between the first axis of rotation and the second extremity of the platform such that in use of the loading apparatus, when the platform is disposed in a loading disposition thereof, the platform is disposed angularly relative to the tabletop for permitting positioning of the elongate cargo so that one end of the elongate cargo is disposed adjacent to the further termination of the open-ended slot, and when the platform is disposed in a transportation disposition thereof, the elongate cargo is supported by the platform, such that during pivoting of the platform from the loading disposition to the transportation disposition, the elongate cargo moves through the open-ended slot and the leg pivots from a loading location thereof to a locking location thereof for locking the distal end of the leg relative to the truck for locking the elongate cargo supported by the platform when disposed in the transportation disposition.

### BACKGROUND OF THE INVENTION

### Field of the Invention

The present invention relates to a loading apparatus for loading an elongate cargo onto a truck.

More specifically, the present invention relates to a loading apparatus for loading a canoe, kayak or the like onto a truck.

### Background of the Invention

The loading of one or more canoes onto a truck for transportation to a lake or leisure site often requires considerable exertion particularly today when the weight of a typical tandem kayak can be 200 lb.

The present invention provides a unique and cost-effective apparatus that can be retrofitted to a truck thus making the loading of a canoe or the like onto a truck a non-stressful, simple and inexpensive operation.

Although in the past, loading means have been proposed for loading cargo onto a truck, these typically include relatively complex and expensive equipment.

An example of a prior proposal has been disclosed in U.S. Pat. No. 8,113,562 to Skoglun. The Skoglun patent discloses a tilting rack system that requires a relatively complex lever-pivot and a slide-pivot.

### SUMMARY OF THE INVENTION

The present invention relates to a loading apparatus for loading an elongate cargo onto a truck, the truck having a cab, tailgate and a truck bed. The loading apparatus includes a table connected to the truck. The table includes a tabletop having a cab end which is disposed above and adjacent to the cab. A tailgate end is disposed above and in a vicinity of the tailgate. The tabletop defines an open-ended slot. The open-ended slot has an open-ended termination and a further termination which is disposed between the tailgate end of the tabletop and the cab end of the tabletop. A support depends from the tabletop for rigidly securing the tabletop to the truck. A platform has a first extremity and a second extremity, the platform being pivotally secured to the tabletop about a first axis of rotation. The first axis of rotation is disposed between the first extremity and the second extremity of the platform. A leg has a proximal end and a distal end, the proximal end of the leg being pivotally secured to the platform about a second axis of rotation. The second axis of rotation is disposed spaced and parallel relative to the first axis of rotation. The second axis of rotation is disposed between the first axis of rotation and the second extremity of the platform such that in use of the loading apparatus, when the platform is disposed in a loading disposition thereof, the platform is disposed angularly relative to the tabletop for permitting positioning of the elongate cargo so that one end of the elongate cargo is disposed adjacent to the further termination of the open-ended slot, and when the platform is disposed in a transportation disposition thereof, the elongate cargo is supported by the platform, such that during pivoting of the platform from the loading disposition to the transportation disposition, the elongate cargo moves through the open-ended slot and the leg pivots from a loading location thereof to a locking location thereof for locking the distal end of the leg relative to the truck for locking the elongate cargo supported by the platform when disposed in the transportation disposition.

In another aspect of the present invention, a loading apparatus is provided for loading an elongate cargo onto a truck, the truck having a cab, tailgate and a truck bed. The loading apparatus includes a frame connected to the truck and a platform having a first extremity and a second extremity. The platform is pivotally secured to the frame about a first axis of rotation, the first axis of rotation being disposed between the first extremity and the second extremity of the platform. A leg has a proximal end and a distal end, the proximal end of the leg being pivotally secured to the platform about a second axis of rotation. The second axis of rotation is disposed spaced and parallel relative to the first axis of rotation with the second axis of rotation being disposed between the first axis of rotation and the second extremity of the platform.

The arrangement is such that in use of the loading apparatus, when the platform is disposed in a loading disposition thereof, the platform is disposed angularly relative to the frame for permitting positioning of the elongate cargo so that one end of the elongate cargo is disposed adjacent to the first extremity of the platform. When the platform is disposed in a transportation disposition thereof, the elongate cargo is supported by the platform such that during pivoting of the platform from the loading disposition to the transportation disposition, the leg pivots from a loading location thereof to a locking location thereof for locking the distal end of the leg relative to the truck for locking the elongate cargo supported by the platform when disposed in the transportation disposition.

Therefore, a primary object of the present invention is the provision of a loading apparatus for loading an elongate cargo onto a truck.

Another objective of the present invention is the provision of a loading apparatus for loading a canoe or Kayak onto a truck.

Yet another object of the present invention is the provision of a loading apparatus of reduced cost for facilitating the easy loading of an elongate cargo onto a truck

A further object of the present invention is the provision of a loading apparatus for loading an elongate cargo onto a truck, the apparatus being easily packaged in kit form for home assembly and for subsequent retrofitting within a cargo bed of a truck.

Other features and advantages of the present invention will be readily apparent to those skilled in the art by a consideration of the detailed description of a preferred embodiment of the present invention contained herein.

Many modifications and variations of the present invention will be readily apparent to those skilled in the art by a consideration of the detailed description contained hereinafter taken in conjunction with the annexed drawings which show a preferred embodiment of the present invention. However, such modifications and variations fall within the spirit and scope of the present invention as defined by the appended claims.

### BRIEF DESCRIPTION OF THE DRAWINGS

FIG. 1 is a side elevational view of a loading apparatus according to the present invention for loading an elongate cargo onto a truck, the truck having a cab, tailgate, and a truck bed;

FIG. 2 is a view taken on the line 2-2 of FIG. 1;

FIG. 3 is a similar view to that shown in FIG. 1 but shows the platform disposed in a transportation disposition thereof;

FIG. 4, is a view taken on the line 4-4 of FIG. 3;

FIG. 5 is a similar view to that shown in FIG. 4 but shows another embodiment of the present invention;

FIG. 6 is a perspective view of the loading apparatus shown in FIG. 1 but without the elongate cargo;

FIG. 7 is a similar view to that shown in FIG. 6 but shows the platform in the loading disposition;

FIG. 8 is a similar view to that shown in FIG. 7 but shows a further modified embodiment of the present invention;

FIG. 9 is a similar view to that shown in FIG. 8 but shows the platform in the transportation disposition;

FIG. 10 is a similar view to that shown in FIG. 8 but shows yet another embodiment of the present invention;

FIG. 11 is a similar view to that shown in FIG. 10 but shows the platform moved from the loading location to the locking location;

FIG. 12 is a perspective view showing another embodiment of the present invention in the loading disposition;

FIG. 13 is a perspective view of the embodiment shown in FIG. 12 but in the transportation disposition;

FIG. 14 is a perspective view showing another embodiment of the present invention in the loading disposition;

FIG. 15 is a perspective view of the embodiment shown in FIG. 14 but in the transportation disposition;

FIG. 16 is a perspective view showing another embodiment of the present invention in the loading disposition; and

FIG. 17 is a perspective view of the embodiment shown in FIG. 16 but in the transportation disposition.

Similar reference characters refer to similar parts throughout the various views of the drawings.

Also, similar parts of the various embodiments of the present invention are indicated by the same reference characters but with a suffix added thereto.

### DETAILED DESCRIPTION OF THE DRAWINGS

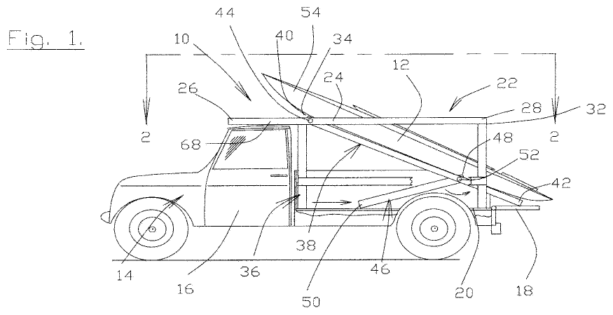

FIG. 1 is a side elevational view of a loading apparatus generally designated 10 according to the present invention for loading an elongate cargo 12 onto a truck generally designated 14. The truck 14 has a cab 16, tailgate 18, and a truck bed 20. As shown in FIG. 1, the loading apparatus 10 includes a table generally designated 22 which is connected to the truck 14. The table 22 includes a tabletop 24 having a cab end 26 which is disposed above and adjacent to the cab 16 and a tailgate end 28 which is disposed above and in a vicinity of the tailgate 18.

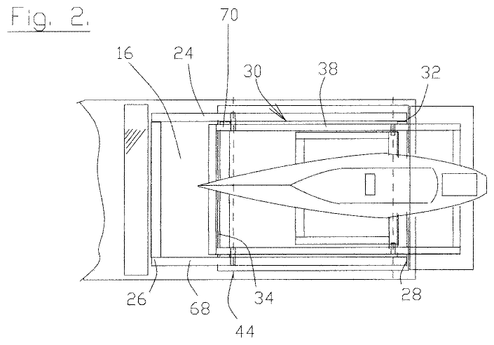

FIG. 2 is a view taken on the line 2-2 of FIG. 1. As shown in FIG. 2, the tabletop 24 defines an open-ended slot generally designated 30. The open-ended slot 30 has an open-ended termination 32 and a further termination 34. The further termination 34 is disposed between the tailgate end 28 of the tabletop 24 and the cab end 26 of the tabletop 24.

As shown in FIG. 1, a support generally designated 36 depends from the tabletop 24 for rigidly securing the tabletop 24 to the truck 14. A platform generally designated 38 has a first and a second extremity 40 and 42 respectively. The platform 38 is pivotally secured to the tabletop 24 about a first axis of rotation 44. The first axis of rotation 44 is disposed between the first extremity 40 and the second extremity 42 of the platform 38. A leg generally designated 46 has a proximal end 48 and a distal end 50 with the proximal end 48 of the leg 46 being pivotally secured to the platform 38 about a second axis of rotation 52. The second axis of rotation 52 is disposed spaced and parallel relative to the first axis of rotation 44. Also, the second axis of rotation 52 is disposed between the first axis of rotation 44 and the second extremity 42 of the platform 38.

The arrangement is such that in use of the loading apparatus 10, when the platform 38 is disposed in a loading disposition thereof as shown in FIG. 1, the platform 38 is disposed angularly relative to the tabletop 24 for permitting positioning of the elongate cargo 12 so that one end 54 of the elongate cargo 12 is disposed adjacent to the further termination 34 of the open-ended slot 30.

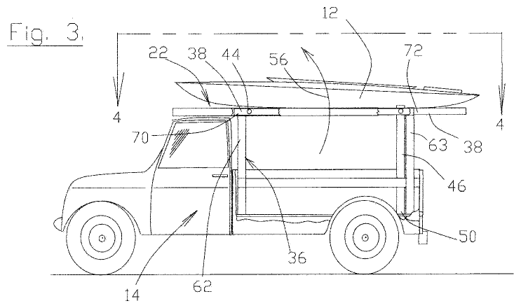

FIG. 3 is a similar view to that shown in FIG. 1 but shows the platform 38 disposed in a transportation disposition thereof. As shown in FIG. 3, when the platform 38 is rotated about the first axis of rotation 44 as indicated by the arrow 56, the platform 38 is disposed in a transportation disposition thereof.

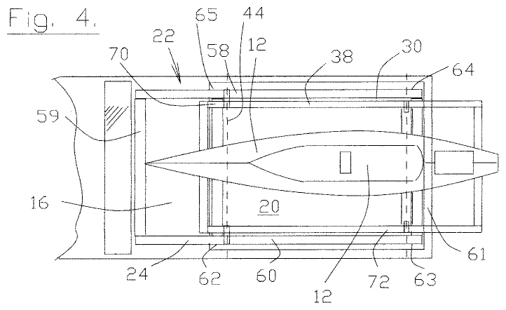

FIG. 4 is a view taken on the line 4-4 of FIG. 3. As shown in FIG. 4, the elongate cargo 12 is supported by the platform 38, such that during pivoting of the platform 38 from the loading disposition shown in FIG. 1, to the transportation disposition shown in FIG. 3 and as indicated by the arrow 56, the one end 54 of the elongate cargo 12 is disposed above the cab 16.

Furthermore, as shown in FIGS. 3 and 4, when the elongate cargo 12 moves through the open-ended slot 30 as shown in FIG. 3, the elongate cargo 12 is supported by the platform 38. At the same time, the leg 46 pivots from a loading location thereof as shown in FIG. 1 to a locking location thereof as shown in FIG. 3 for locking the distal end 50 of the leg 46 relative to the truck 14 for locking the elongate cargo 12 supported by the platform 38 when disposed in the transportation disposition as shown in FIG. 3.

As shown in FIG. 4, the table 22 further includes a plurality of elongate angular sections 58, 59, 60 and 61. Each section such as section 58 of the plurality of elongate angular sections 58 to 61 is rigidly secured to an adjacent section such as section 59.

More specifically, each section such as section 58 of the plurality of elongate angular sections 58 to 61 is fabricated from aluminum.

Also, each section such as section 58 of the plurality of aluminum elongate angular sections 58 to 61 is welded to an adjacent section such as section 59.

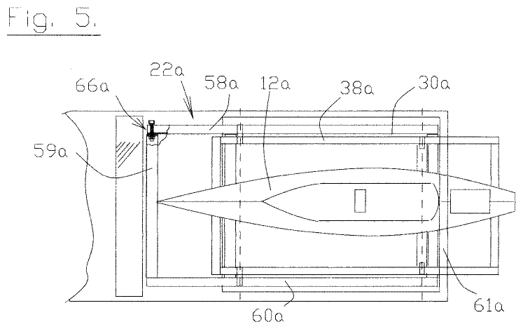

FIG. 5 is a similar view to that shown in FIG. 4 but shows another embodiment of the present invention. As shown in FIG. 5, a fastener generally designated 66a is provided for fastening each section such as section 58a of the plurality of elongate angular sections 58a to 61a to an adjacent section such as section 59a.

As shown in FIG. 1, the tabletop 24 includes a cantilevered portion 68 extending from the first axis of rotation 44 to the cab end 26 of the tabletop 24. The cantilevered portion 68 is disposed above and substantially horizontally over the cab 16.

Additionally, as shown in FIGS. 1 and 2, the open-ended termination 32 is disposed adjacent to the tailgate end 28 of the tabletop 24.

As shown in FIGS. 3 and 4, the support 36 further includes a plurality of arms 62, 63, 64 and 65. Each arm such as arm 62 of the plurality of arms 62 to 65 depends from the tabletop 24 for supporting the tabletop 24 in a substantially horizontal disposition relative to the truck bed 20.

As shown in FIG. 2, the platform 38 further includes an upstream portion 70 disposed upstream relative to the first axis of rotation 44. The upstream portion 70 of the platform 38 is disposed substantially horizontally relative to the cab 16 when the platform 38 is disposed in the transportation disposition thereof as shown in FIGS. 3 and 4.

Also, as shown in FIGS. 3 and 4, a downstream portion 72 of the platform 38 is disposed downstream relative to the first axis of rotation 44. The upstream portion 70 of the platform 38 is disposed substantially horizontally relative to the truck bed 20 when the platform 38 is disposed in the transportation disposition thereof as shown in FIGS. 3 and 4.

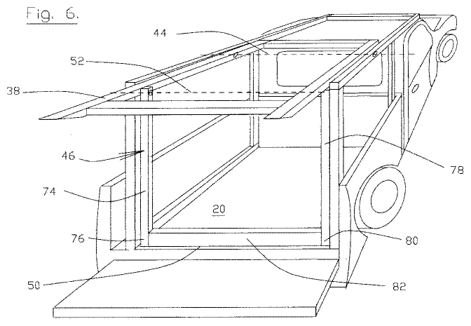

FIG. 6 is a perspective view of the loading apparatus 10 shown in FIG. 1 but without the elongate cargo. As shown in FIG. 6, the leg 46 further includes a first member 74 having a distal extremity 76. The first member 74 extends from the second axis of rotation 52. A second member 78 of the leg 46 has a further distal extremity 80, the second member 78 extending from the second axis of rotation 52. The second member 78 is disposed laterally spaced and parallel relative to the first member 74.

Additionally, a lateral member 82 extends from between the second axis of rotation 52 and the distal extremity 76 of the first member 74 to between the second axis of rotation 52 and the further distal extremity 80 of the second member 78. The arrangement is such that when the leg 46 is disposed in the locking location as shown in FIG. 6, the lateral member 82 interacts with and locks relative to the truck bed 20 for supporting the platform 38 in a substantially horizontal disposition thereof when the platform 38 is in the transportation disposition as shown in FIG. 6.

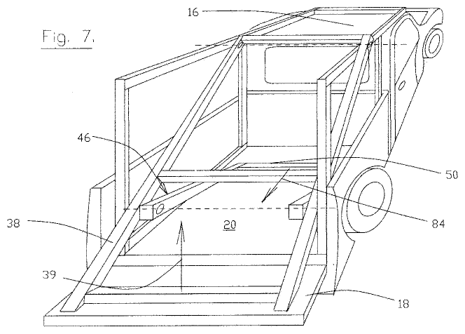

FIG. 7 is a similar view to that shown in FIG. 6 but shows the platform 38 in the loading disposition. As shown in FIG. 7, the distal end 50 of the leg 46 interacts with and slidably contacts the truck bed 20. The arrangement is such that when the platform 38 pivots about the first axis of rotation 44 from the loading disposition as shown in FIG. 7 to the transportation disposition as shown in FIG. 6, the distal end 50 of the leg 46 slides along the truck bed 20 as indicated by the arrow 84 from the loading location as shown in FIG. 7 to the to the locking location as shown in FIG. 6.

The distal end 50 of the leg 46 automatically slides along the truck bed 20 assisted by gravity, in a direction from the cab 16 towards the tailgate 18 as indicated by the arrow 84 when the platform 38 is lifted as indicated by the arrow 39, from the loading disposition as shown in FIG. 7 to the transportation disposition of the platform 38 as shown in FIG. 6.

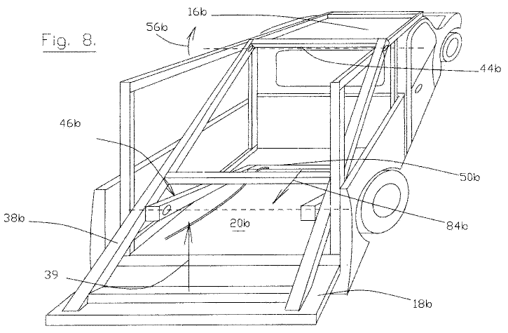

FIG. 8 is a similar view to that shown in FIG. 7 but shows a further modified embodiment of the present invention. As shown in FIG. 8, the distal end 50b of the leg 46b interacts with and slidably contacts the truck bed 20b. The arrangement is such that the platform 38b pivots about the first axis of rotation 44b from the loading disposition as shown in FIG. 8 to the transportation disposition.

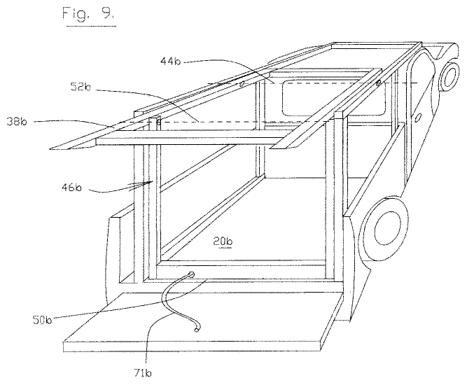

FIG. 9 is a similar view to that shown in FIG. 8 but shows the platform 38b in the transportation disposition. As shown in FIG. 9, the platform 38b has been moved to the transportation disposition. During such movement, the distal end 50b of the leg 46b slides along the truck bed 20b from the loading location as shown in FIG. 8 to the locking location as shown in FIG. 9.

As shown in FIG. 8, the leg 46b is urged as indicated by the arrow 84b from the cab 16b towards the tailgate 18b such that when the leg 46b is being urged in the direction 84b, the platform 38b is leveraged by an interaction between and cooperation between the distal end 50b of the leg 46b and the truck bed 20b for pivoting the platform 38b and elongate cargo supported thereon to the transportation disposition as indicated by the arrow 39b as shown in FIG. 8.

As shown in FIG. 9, a rope or cable 71b is provided for urging the distal end 50b in the direction 84b as shown in FIGS. 8 and 9.

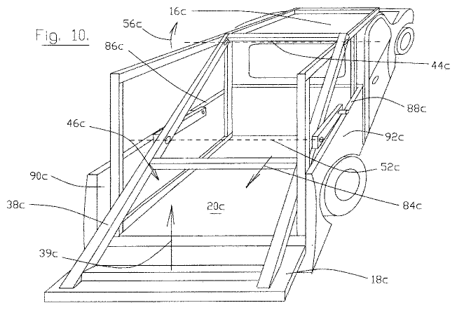

FIG. 10 is a similar view to that shown in FIG. 8 but shows yet another embodiment of the present invention. As shown in FIG. 10, the distal extremities 76c and 80c of the leg 46c interact with and slidably contact longitudinally extending side rails 86c and 88c respectively disposed at the top of side walls 90c and 92c extending upwardly from the truck bed 20c. The arrangement is such that when the platform 38c pivots about the first axis of rotation 44c from the loading disposition as shown in FIG. 10 to the transportation disposition, the distal extremities 76c and 80c of the leg 46c slide along the longitudinally extending side rails 86c and 88c respectively.

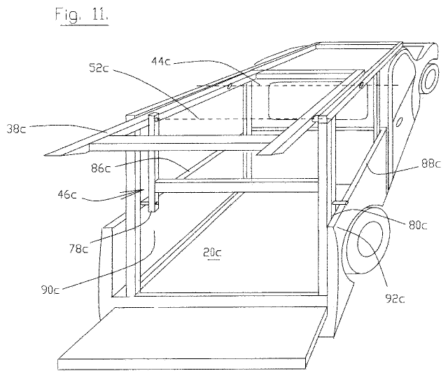

FIG. 11 is a similar view to that shown in FIG. 10 but shows the platform 38c moved from the loading location shown in FIG. 10 to the locking location shown in FIG. 11. The embodiment shown in FIGS. 10 and 11 has an advantage in that any equipment stowed on the truck bed 20c is not affected by movement of the distal extremities 76c and 80c along the truck bed 20c.

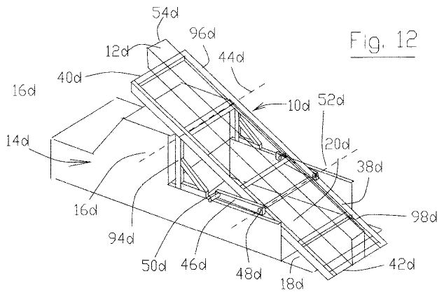

FIG. 12 is a perspective view showing another embodiment of the present invention in the loading disposition. As shown in FIG. 12, a loading apparatus generally designated 10d is provided for loading an elongate cargo 12d onto a truck 14d, the truck 14d having a cab 16d, tailgate 18d and a truck bed 20d. The loading apparatus 10d includes a frame 94d connected to the truck 14d. A platform 38d has a first extremity 40d and a second extremity 42d, the platform 38d being pivotally secured to the frame 94d about a first axis of rotation 44d. The first axis of rotation 44d is disposed between the first extremity 40d and the second extremity 42d of the platform 38d. A leg 46d has a proximal end 48d and a distal end 50d, the proximal end 48d of the leg 46d being pivotally secured to the platform 38d about a second axis of rotation 52d. The second axis of rotation 52d is disposed spaced and parallel relative to the first axis of rotation 44d. The second axis of rotation 52d is disposed between the first axis of rotation 44d and the second extremity 42d of the platform 38d.

The arrangement is such that in use of the loading apparatus 10d, when the platform 38d is disposed in a loading disposition thereof as shown in FIG. 12, the platform 38d is disposed angularly relative to the frame 94d for permitting positioning of the elongate cargo 12d so that one end 54d of the elongate cargo 12d is disposed adjacent to the first extremity 40d of the platform 38d.

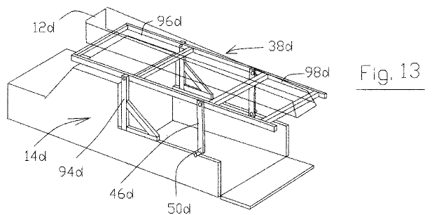

FIG. 13 is a perspective view of the embodiment shown in FIG. 12 but in the transportation disposition. As shown in FIG. 13, when the platform 38d is disposed in the transportation disposition thereof, the elongate cargo 12d is supported by the platform 38d such that during pivoting of the platform 38d from the loading disposition to the transportation disposition, the leg 46d pivots from a loading location thereof as shown in FIG. 12 to a locking location thereof as shown in FIG. 13 for locking the distal end 50d of the leg 46d relative to the truck 14d for locking the elongate cargo 12d supported by the platform 38d when disposed in the transportation disposition.

As shown in FIGS. 12 and 13, the platform 38d includes a first part 96d which extends from the first axis of rotation 44d to the first extremity 40d such that the first part 96d is disposed over and above the cab 16d. A second part 98d extends from the first axis of rotation 44d to the second extremity 42d. The first axis of rotation 44d is disposed between the cab 16d and the tailgate 18d and adjacent to the cab 16d.

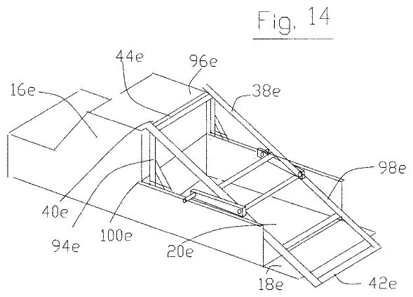

FIG. 14 is a perspective view showing another embodiment of the present invention in the loading disposition. As shown in FIG. 14, a platform 38e includes a first part 96e extending from the first axis of rotation 44e to the first extremity 40e such that the first part 96e is disposed over and above a forward portion 100e of the truck bed 20e. A second part 98e extends from the first axis of rotation 44e to the second extremity 42e. The first axis of rotation 44e is disposed between the cab 16e and the tailgate 18e and adjacent to the cab 16e.

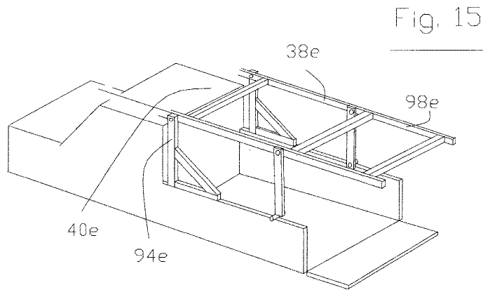

FIG. 15 is a perspective view of the embodiment shown in FIG. 14 but in the transportation disposition.

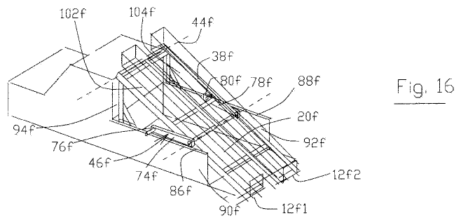

FIG. 16 is a perspective view showing another embodiment of the present invention in the loading disposition. As shown in FIG. 16, a platform generally designated 38f includes a first pivoting ramp 102f for supporting the elongate cargo 12f1. A second pivoting ramp 104f is disposed laterally relative to the first pivoting ramp 102f for supporting a further elongate cargo 12f2, such that the first pivoting ramp 102f and the second pivoting ramp 104f rotate independently relative to each other about the first axis of rotation 44f.

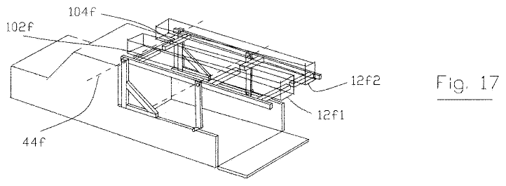

FIG. 17 is a perspective view of the embodiment shown in FIG. 16 but in the transportation disposition.

As shown in FIGS. 16 and 17, the leg 46f includes a first member 74f having a distal extremity 76f which cooperates with a side rail 86f of a side wall 90f extending upwardly from the truck bed 20f. A second member 78f has a further distal extremity 80f which cooperates with a further side rail 88f of a further side wall 92f extending upwardly from the truck bed 20f.

As shown in each of the embodiments shown in FIGS. 12 and 13, FIGS. 14 and 15, and FIGS. 16 and 17, the frame 94d, 94e and 94f respectively, the frame 94d, 94e and 94f respectively is rigidly secured respectively to longitudinally extending rails 86d and 88d, 86e and 86e, and 86f and 88f.

In operation of the loading apparatus 10 according to the present invention, the elongate cargo 12 which may be a Kayak or canoe is positioned with one end 54 of the elongate cargo 12 extending through the open-ended slot 30 of the table-top when the platform is in the loading disposition as shown in FIG. 1. The platform 38 is then lifted about the first axis of rotation 44 and the leg 46 will then slide along the truck bed 20 until the distal end 50 of the leg locks the platform in the transportation disposition as shown in FIG. 3.

In the alternative embodiment, the lateral member 82b of the leg 46b can be pulled towards the tailgate 18b as indicated by the arrow 84b until the distal end 50b of the leg 46b locks the platform 38b in the transportation disposition.

In the further alternative embodiment of the present invention, the leg 46c is shorter and each distal extremity 76c and 80c slidingly cooperate with a respective longitudinally extending side rails 86c and 88c secured respectively at the top of each side wall 90c and 92c of the truck bed 20c.

In the preferred embodiment of the present invention as shown in FIGS. 12 and 13, the frame 94d and the distal ends 50d cooperate with the side rails 86d and 88d thus not interfering with the remaining cargo space afforded by the truck bed 20d under the apparatus 10d.

The arrangement shown in FIGS. 14 and 15 are suitable for the transportation of a shorter kayak or the like that would not extend over the cab 16e.

FIGS. 16 and 17 show a side-by-side loading arrangement in which the platform 38f includes a first pivoting ramp 102f for supporting a first kayak and a second pivoting ramp 104f for loading a second kayak so that the kayaks can be separately loaded side by side.

The various embodiments shown in FIGS. 1-11 also include a rope secured to the lateral member 82 in order to assist in pulling the leg 46 from the loading location to the locking location. A rope and pulley system may be included with the pulley secured adjacent to the cab 16 for assisting in the release of the leg 46 from the locking location. Furthermore, a latch can be provided for latching the leg 46 in the locking location. The latch may be of the type typically used for latching a tailgate such as tailgate 18.

The present invention provides a unique loading apparatus for loading an elongate cargo such as a Kayak or canoe onto a truck.

What is claimed is:

1. A loading apparatus for loading an elongate cargo onto a truck, the truck having a cab, tailgate and a truck bed, said loading apparatus comprising:
a table connected to the truck, said table including:
a tabletop having a cab end which is disposed above and adjacent to the cab and a tailgate end disposed above and in a vicinity of the tailgate, said tabletop defining an open-ended slot;
said open-ended slot having an open-ended termination and a further termination which is disposed between said tailgate end of said tabletop and said cab end of said tabletop;
a support depending from said tabletop for rigidly securing said tabletop to the truck;
a platform having a first extremity and a second extremity, said platform being pivotally secured to said tabletop about a first axis of rotation, said first axis of rotation being disposed between said first extremity and said second extremity of said platform; and
a leg having a proximal end and a distal end, said proximal end of said leg being pivotally secured to said platform about a second axis of rotation, said second axis of rotation being disposed spaced and parallel relative to said first axis of rotation, said second axis of rotation being disposed between said first axis of rotation and said second extremity of said platform such that in use of said loading apparatus, when said platform is disposed in a loading disposition thereof, said platform is disposed angularly relative to said tabletop for permitting positioning of the elongate cargo so that one end of the elongate cargo is disposed adjacent to said further termination of said open-ended slot, and when said platform is disposed in a transportation disposition thereof, said elongate cargo is supported by said platform, such that during pivoting of said platform from said loading disposition to said transportation disposition, the elongate cargo moves through said open-ended slot and said leg pivots from a loading location thereof to a locking location thereof for locking said distal end of said leg relative to the truck for locking the elongate cargo supported by said platform when disposed in said transportation disposition.

2. A loading apparatus as set forth in claim 1 wherein
said table further includes:
a plurality of elongate angular sections, each section of said plurality of elongate angular sections being rigidly secured to an adjacent section.

3. A loading apparatus as set forth in claim 2 wherein
each section of said plurality of elongate angular sections is fabricated from aluminum.

4. A loading apparatus as set forth in claim 3 wherein
each section of said plurality of elongate angular sections is welded to an adjacent section.

5. A loading apparatus as set forth in claim 3 further including:
a fastener for fastening each section of said plurality of elongate angular sections to an adjacent section.

6. A loading apparatus as set forth in claim 1 wherein
said tabletop includes:
a cantilevered portion extending from said first axis of rotation to said cab end of said tabletop, said cantilevered portion being disposed above and over the cab.

7. A loading apparatus as set forth in claim 1 wherein
said open-ended termination is disposed adjacent to said tailgate end of said tabletop.

8. A loading apparatus as set forth in claim 1 wherein
said support further includes:
a plurality of arms, each arm of said plurality of arms depending from said tabletop for supporting said tabletop in a substantially horizontal disposition relative to the truck bed.

9. A loading apparatus as set forth in claim 1 wherein
said platform further includes:
an upstream portion disposed upstream relative to said first axis of rotation, said upstream portion of said platform being disposed substantially horizontally relative to the cab when said platform is disposed in said transportation disposition thereof;
a downstream portion disposed downstream relative to said first axis of rotation, said upstream portion of said platform being disposed substantially horizontally relative to the truck bed when said platform is disposed in said transportation disposition thereof.

10. A loading apparatus as set forth in claim 1 wherein
said leg further includes:
a first member having a distal extremity, said first member extending from said second axis of rotation;
a second member having a further distal extremity, said second member extending from said second axis of rotation, said second member being disposed laterally spaced and parallel relative to said first member;
a lateral member extending from between said second axis of rotation and said distal extremity of said first member to between said second axis of rotation and said further distal extremity of said second member such that when said leg is disposed in said locking location, said lateral member interacts with and locks relative to the truck bed for supporting said platform and elongate cargo resting thereon in a substantially horizontal disposition thereof when said platform is in said transportation disposition. cm 11. A loading apparatus as set forth in claim 1 wherein
said distal end of said leg interacts and slidably contacts the truck bed such that when said platform pivots about said first axis of rotation from said loading disposition to said transportation disposition, said distal end of said leg slides along the truck bed from said loading location to said to said locking location.

12. A loading apparatus as set forth in claim 11 wherein
said distal end of said leg automatically slides along the truck bed in a direction from the cab towards the tailgate assisted by gravity when said platform is lifted from said loading disposition to said transportation disposition of said platform.

13. A loading apparatus as set forth in claim 1 wherein
said distal end of said leg interacts with and slidably contacts the truck bed such that when said platform pivots about said first axis of rotation from said loading disposition to said transportation disposition, said distal end of said leg slides along the truck bed from said loading location to said to said locking location, said leg being urged in a direction from the cab towards the tailgate such that when said leg is being urged in said direction, said platform is leveraged by an interaction with and cooperation between said distal end of said leg and the truck bed for pivoting said platform and elongate cargo supported thereon to said transportation disposition.

14. A loading apparatus as set forth in claim 1 wherein
said distal end of said leg interacts with and slidably contacts longitudinally extending side rails disposed at the top of side walls extending upwardly from the truck bed such that when said platform pivots about said first axis of rotation from said loading disposition to said transportation disposition, said distal extremities of said leg slide along the longitudinally extending side rails from said loading location to said locking location.

15. A loading apparatus for loading an elongate cargo onto a truck, the truck having a cab, tailgate and a truck bed, said loading apparatus comprising:
a table connected to the truck, said table including:
a tabletop having a cab end which is disposed above and adjacent to the cab and a tailgate end disposed above and in a vicinity of the tailgate, said tabletop defining an open-ended slot;
said open-ended slot having an open-ended termination and a further termination which is disposed between said tailgate end of said tabletop and said cab end of said tabletop;
a support depending from said tabletop for rigidly securing said tabletop to the truck;
a platform having a first extremity and a second extremity, said platform being pivotally secured to said tabletop about a first axis of rotation, said first axis of rotation being disposed between said first extremity and said second extremity of said platform;
a leg having a proximal end and a distal end, said proximal end of said leg being pivotally secured to said platform about a second axis of rotation, said second axis of rotation being disposed spaced and parallel relative to said first axis of rotation, said second axis of rotation being disposed between said first axis of rotation and said second extremity of said platform such that in use of said loading apparatus, when said platform is disposed in a loading disposition thereof, said platform is disposed angularly relative to said tabletop for permitting positioning of the elongate cargo so that one end of the elongate cargo is disposed adjacent to said further termination of said open-ended slot, and when said platform is disposed in a transportation disposition thereof, said elongate cargo is supported by said platform, such that during pivoting of said platform from said loading disposition to said transportation disposition, the elongate cargo moves through said open-ended slot and said leg pivots from a loading location thereof to a locking location thereof for locking said distal end of said leg relative to the truck for locking the elongate cargo supported by said platform when disposed in said transportation disposition;
said table further including:
a plurality of elongate angular sections, each section of said plurality of elongate angular sections being rigidly secured to an adjacent section;
each section of said plurality of elongate angular sections being fabricated from aluminum;
a fastener for fastening each section of said plurality of elongate angular sections to an adjacent section such that packaging of said loading apparatus for shipment and subsequent home assembly of said loading apparatus is facilitated;
said tabletop including:
a cantilevered portion extending from said first axis of rotation to said cab end of said tabletop, said cantilevered portion being disposed above and over the cab;
said open-ended termination is disposed adjacent to said tailgate end of said tabletop;
said support further including:
a plurality of arms, each arm of said plurality of arms depending from said tabletop for supporting said tabletop in a substantially horizontal disposition relative to the truck bed;
said platform further including:
an upstream portion disposed upstream relative to said first axis of rotation, said upstream portion of said platform being disposed substantially horizontally relative to the cab when said platform is disposed in said transportation disposition thereof;
a downstream portion disposed downstream relative to said first axis of rotation, said upstream portion of said platform being disposed substantially horizontally relative to the truck bed when said platform is disposed in said transportation disposition thereof;
said leg further including:
a first member having a distal extremity, said first member extending from said second axis of rotation;
a second member having a further distal extremity, said second member extending from said second axis of rotation, said second member being disposed laterally spaced and parallel relative to said first member;
a lateral member extending from between said second axis of rotation and said distal extremity of said first member to between said second axis of rotation and said further distal extremity of said second member such that when said leg is disposed in said locking location, said lateral member interacts with and locks relative to the truck bed for supporting said platform and elongate cargo resting thereon in a substantially horizontal disposition thereof when said platform is in said transportation disposition;
said distal end of said leg interacts and slidably contacts the truck bed such that when said platform pivots about said first axis of rotation from said loading disposition to said transportation disposition, said distal end of said leg slides along the truck bed from said loading location to said to said locking location; and
said distal end of said leg automatically slides along the truck bed in a direction from the cab towards the tailgate assisted by gravity when said platform is lifted from said loading disposition to said transportation disposition of said platform.

16. A loading apparatus for loading an elongate cargo onto a truck, the truck having a cab, tailgate and a truck bed, said loading apparatus comprising:
a frame connected to the truck;
a platform having a first extremity and a second extremity, said platform being pivotally secured to said frame about a first axis of rotation, said first axis of rotation being disposed between said first extremity and said second extremity of said platform; and
a leg having a proximal end and a distal end, said proximal end of said leg being pivotally secured to said platform about a second axis of rotation, said second axis of rotation being disposed spaced and parallel relative to said first axis of rotation, said second axis of rotation being disposed between said first axis of rotation and said second extremity of said platform such that in use of said loading apparatus, when said platform is disposed in a loading disposition thereof, said platform is disposed angularly relative to said frame for permitting positioning of the elongate cargo so that one end of the elongate cargo is disposed adjacent to said first extremity of said platform, and when said platform is disposed in a transportation disposition thereof, said elongate cargo is supported by said platform such that during pivoting of said platform from said loading disposition to said transportation disposition, said leg pivots from a loading location thereof to a locking location thereof for locking said distal end of said leg relative to the truck for locking the elongate cargo supported by said platform when disposed in said transportation disposition.

17. A loading apparatus as set forth in claim 16 wherein
said platform includes:
a first part extending from said first axis of rotation to said first extremity such that said first part is disposed over and above the cab;
a second part extending from said first axis of rotation to said second extremity;
said first axis of rotation being disposed between the cab and the tailgate and adjacent to the cab.

18. A loading apparatus as set forth in claim 16 wherein
said platform includes:
a first part extending from said first axis of rotation to said first extremity such that said first part is disposed over and above a forward portion of the truck bed;
a second part extending from said first axis of rotation to said second extremity;
said first axis of rotation being disposed between the cab and the tailgate and adjacent to the cab.

19. A loading apparatus as set forth in claim 16 wherein
said platform includes:
a first pivoting ramp for supporting the elongate cargo;
a second pivoting ramp disposed laterally relative to said first pivoting ramp for supporting a further elongate cargo, such that said first pivoting ramp and said second pivoting ramp rotate independently relative to each other about said first axis of rotation.

20. A loading apparatus as set forth in claim 16 wherein
said leg includes:
a first member having a distal extremity which cooperates with a side rail of a side wall extending upwardly from the truck bed;
a second member having a further distal extremity which cooperates with a further side rail of a further side wall extending upwardly from the truck bed.
